(19) United States
(12) Patent Application Publication
(10) Pub. No.: US 2017/0031981 A1
(43) Pub. Date: Feb. 2, 2017

(54) FACILITATING EXECUTION OF EXTERNAL SEARCH COMMANDS DURING QUERY PROCESSING

(71) Applicant: Splunk Inc., San Francisco, CA (US)

(72) Inventors: Jacob B. Leverich, San Francisco, CA (US); Itay A. Neeman, Seattle, WA (US); David R. Marquardt, San Francisco, CA (US)

(73) Assignee: SPLUNK INC., San Francisco, CA (US)

(21) Appl. No.: 14/815,725

(22) Filed: Jul. 31, 2015

(51) Int. Cl. G06F 17/30

(52) U.S. Cl. CPC G06F 17/30442; G06F 17/30507

(57) ABSTRACT

The disclosed embodiments relate to a system, a method and instructions embodied on a non-transitory computer-readable storage medium that facilitate executing an external command during query processing. While commencing execution of a query that streams data through a pipeline comprising consecutive commands that are chained together (including the external command), the system launches an external process that executes the external command. Next, as chunks of data are subsequently streamed through the pipeline during query processing, the system uses a transport protocol to communicate the chunks of data to and from the external process to facilitate executing the external command on the chunks of data, without terminating and re-launching the external process between chunks of data.

### BACKGROUND

Field of the Invention

The disclosed embodiments generally relate to query-processing systems. More specifically, the disclosed embodiments relate to a query-processing system that facilitates executing external search commands during query processing.

Related Art

Modern data centers often comprise thousands of host computer systems that operate collectively to service requests from even larger numbers of remote clients. During operation, these data centers generate significant volumes of performance data and diagnostic information that need to be analyzed to diagnose performance and security problems. To monitor such large volumes of data, organizations often use event-based systems, such as the SPLUNK® ENTERPRISE system produced by Splunk Inc. of San Francisco, Calif., to store and process their performance data and diagnostic information. The Splunk system can be used to process large volumes of data by using queries specified in Splunk's Search Processing Language (SPL).

Search languages, such as SPL, presently allow users to execute custom search commands. At present, when a system executes a custom search command (for example, written as a script in Python), the system runs an external process for each chunk of results it has to process. This means the system has to start the external process, start both Python and the script, send results to the script, get results back, and then terminate the external process. Having to do this for each chunk of results incurs a large amount of overhead, making custom search commands extremely slow. For some custom search commands, a large portion of this slowdown results from importing complex libraries in the script, which can take a significant amount of time (often hundreds of milliseconds). Another source of overhead arises from transferring large sets of search results to and from the external process for streaming commands, wherein many of the fields in the search results are not actually accessed by the custom search command.

Hence, what is needed is a system that facilitates executing custom search commands without the above-described performance problems.

### SUMMARY

The disclosed embodiments relate to a system, a method and instructions embodied on a non-transitory computer-readable storage medium that facilitate executing an external command during query processing. This system operates as follows. While commencing execution of a query that streams data through a pipeline comprising consecutive commands that are chained together (including the external command), the system launches an external process that executes the external command. Next, as chunks of data are subsequently streamed through the pipeline during query processing, the system uses a transport protocol to communicate the chunks of data to and from the external process to facilitate executing the external command on the chunks of data, without terminating and re-launching the external process between chunks of data.

In some embodiments, the system terminates the external process after query processing is complete.

In some embodiments, the transport protocol supports a partial-chunk mode, during which a single chunk is sent to the external process, and in response, multiple partial chunks are received from the external process.

In some embodiments, the data comprises events containing previously gathered data.

In some embodiments, during a selected-fields mode, communicating the chunks of data to and from the external process includes communicating only selected fields from each of the events to the external process.

In some embodiments, the external process does at least one of the following: (1) edits one or more fields in the events; (2) adds one or more fields to the events; and (3) removes one or more events entirely.

In some embodiments, the external process executes an externally defined script.

In some embodiments, the system spawns a separate thread to deallocate events that have been deleted.

In some embodiments, the external process is configured to execute code specified in multiple programming languages.

### BRIEF DESCRIPTION OF THE DRAWINGS

FIG. 1 presents a block diagram of an event-processing system in accordance with the disclosed embodiments.

FIG. 2 presents a flow chart illustrating how indexers process, index, and store data received from forwarders in accordance with the disclosed embodiments.

FIG. 3 presents a flow chart illustrating how a search head and indexers perform a search query in accordance with the disclosed embodiments.

FIG. 4 presents a block diagram of a system for processing search requests that uses extraction rules for field values in accordance with the disclosed embodiments.

FIG. 5 illustrates an exemplary search query received from a client and executed by search peers in accordance with the disclosed embodiments.

FIG. 6A illustrates a search screen in accordance with the disclosed embodiments.

FIG. 6B illustrates a data summary dialog that enables a user to select various data sources in accordance with the disclosed embodiments.

FIG. 7 illustrates a system for executing a query that includes an external search command in accordance with the disclosed embodiments.

FIG. 8 presents a flow chart illustrating the process of executing a query that includes an external search command in accordance with the disclosed embodiments.

FIG. 9 presents a flow chart illustrating how a selected-fields mode operates in accordance with the disclosed embodiments.

### DETAILED DESCRIPTION

The disclosed embodiments relate to a system, a method and instructions embodied on a non-transitory computer-readable storage medium that facilitates executing external search commands during query processing. (Note that throughout this specification and the attached claims we refer to “the system,” “the method” and “the instructions embodied on a non-transitory computer-readable storage medium” collectively as “the system.”) The system is described in more detail below, but we first describe the structure of an event-based framework in which the system operates.

### 1.1 System Overview

Modern data centers often comprise thousands of host computer systems that operate collectively to service requests from even larger numbers of remote clients. During operation, these data centers generate significant volumes of performance data and diagnostic information that can be analyzed to quickly diagnose performance problems. In order to reduce the size of this performance data, the data is typically pre-processed prior to being stored based on anticipated data-analysis needs. For example, pre-specified data items can be extracted from the performance data and stored in a database to facilitate efficient retrieval and analysis at search time. However, the rest of the performance data is not saved and is essentially discarded during pre-processing. As storage capacity becomes progressively cheaper and more plentiful, there are fewer incentives to discard this performance data and many reasons to keep it.

This plentiful storage capacity is presently making it feasible to store massive quantities of minimally processed performance data at “ingestion time” for later retrieval and analysis at “search time.” Note that performing the analysis operations at search time provides greater flexibility because it enables an analyst to search all of the performance data, instead of searching pre-specified data items that were stored at ingestion time. This enables the analyst to investigate different aspects of the performance data instead of being confined to the pre-specified set of data items that was selected at ingestion time.

However, analyzing massive quantities of heterogeneous performance data at search time can be a challenging task. A data center may generate heterogeneous performance data from thousands of different components, which can collectively generate tremendous volumes of performance data that can be time-consuming to analyze. For example, this performance data can include data from system logs, network packet data, sensor data, and data generated by various applications. Also, the unstructured nature of much of this performance data can pose additional challenges because of the difficulty of applying semantic meaning to unstructured data, and the difficulty of indexing and querying unstructured data using traditional database systems.

These challenges can be addressed by using an event-based system, such as the SPLUNK® ENTERPRISE system produced by Splunk Inc. of San Francisco, Calif., to store and process performance data. The SPLUNK® ENTERPRISE system is the leading platform for providing real-time operational intelligence that enables organizations to collect, index, and harness machine-generated data from various websites, applications, servers, networks, and mobile devices that power their businesses. The SPLUNK® ENTERPRISE system is particularly useful for analyzing unstructured performance data, which is commonly found in system log files. Although many of the techniques described herein are explained with reference to the SPLUNK® ENTERPRISE system, the techniques are also applicable to other types of data server systems.

In the SPLUNK® ENTERPRISE system, performance data is stored as “events,” wherein each event comprises a collection of performance data and/or diagnostic information that is generated by a computer system and is correlated with a specific point in time. Events can be derived from “time series data,” wherein time series data comprises a sequence of data points (e.g., performance measurements from a computer system) that are associated with successive points in time and are typically spaced at uniform time intervals. Events can also be derived from “structured” or “unstructured” data. Structured data has a predefined format, wherein specific data items with specific data formats reside at predefined locations in the data. For example, structured data can include data items stored in fields in a database table. In contrast, unstructured data does not have a predefined format. This means that unstructured data can comprise various data items having different data types that can reside at different locations. For example, when the data source is an operating system log, an event can include one or more lines from the operating system log containing raw data that includes different types of performance and diagnostic information associated with a specific point in time. Examples of data sources from which an event may be derived include, but are not limited to: web servers; application servers; databases; firewalls; routers; operating systems; and software applications that execute on computer systems, mobile devices, and sensors. The data generated by such data sources can be produced in various forms including, for example and without limitation, server log files, activity log files, configuration files, messages, network packet data, performance measurements and sensor measurements. An event typically includes a timestamp that may be derived from the raw data in the event, or may be determined through interpolation between temporally proximate events having known timestamps.

The SPLUNK® ENTERPRISE system also facilitates using a flexible schema to specify how to extract information from the event data, wherein the flexible schema may be developed and redefined as needed. Note that a flexible schema may be applied to event data “on the fly,” when it is needed (e.g., at search time), rather than at ingestion time of the data as in traditional database systems. Because the schema is not applied to event data until it is needed (e.g., at search time), it is referred to as a “late-binding schema.”

During operation, the SPLUNK® ENTERPRISE system starts with raw data, which can include unstructured data, machine data, performance measurements or other time-series data, such as data obtained from weblogs, syslogs, or sensor readings. It divides this raw data into “portions,” and optionally transforms the data to produce timestamped events. The system stores the timestamped events in a data store, and enables a user to run queries against the data store to retrieve events that meet specified criteria, such as containing certain keywords or having specific values in defined fields. Note that the term “field” refers to a location in the event data containing a value for a specific data item.

As noted above, the SPLUNK® ENTERPRISE system facilitates using a late-binding schema while performing queries on events. A late-binding schema specifies “extraction rules” that are applied to data in the events to extract values for specific fields. More specifically, the extraction rules for a field can include one or more instructions that specify how to extract a value for the field from the event data. An extraction rule can generally include any type of instruction for extracting values from data in events. In some cases, an extraction rule comprises a regular expression, in which case the rule is referred to as a “regex rule.”

In contrast to a conventional schema for a database system, a late-binding schema is not defined at data ingestion time. Instead, the late-binding schema can be developed on an ongoing basis until the time a query is actually executed. This means that extraction rules for the fields in a query may be provided in the query itself, or may be located during execution of the query. Hence, as an analyst learns more about the data in the events, the analyst can continue to refine the late-binding schema by adding new fields, deleting fields, or changing the field extraction rules until the next time the schema is used by a query. Because the SPLUNK® ENTERPRISE system maintains the underlying raw data and provides a late-binding schema for searching the raw data, it enables an analyst to investigate questions that arise as the analyst learns more about the events.

In the SPLUNK® ENTERPRISE system, a field extractor may be configured to automatically generate extraction rules for certain fields in the events when the events are being created, indexed, or stored, or possibly at a later time. Alternatively, a user may manually define extraction rules for fields using a variety of techniques.

Also, a number of “default fields” that specify metadata about the events rather than data in the events themselves can be created automatically. For example, such default fields can specify: a timestamp for the event data; a host from which the event data originated; a source of the event data; and a source type for the event data. These default fields may be determined automatically when the events are created, indexed or stored.

In some embodiments, a common field name may be used to reference two or more fields containing equivalent data items, even though the fields may be associated with different types of events that possibly have different data formats and different extraction rules. By enabling a common field name to be used to identify equivalent fields from different types of events generated by different data sources, the system facilitates use of a “common information model” (CIM) across the different data sources.

### 1.2 Data Server System

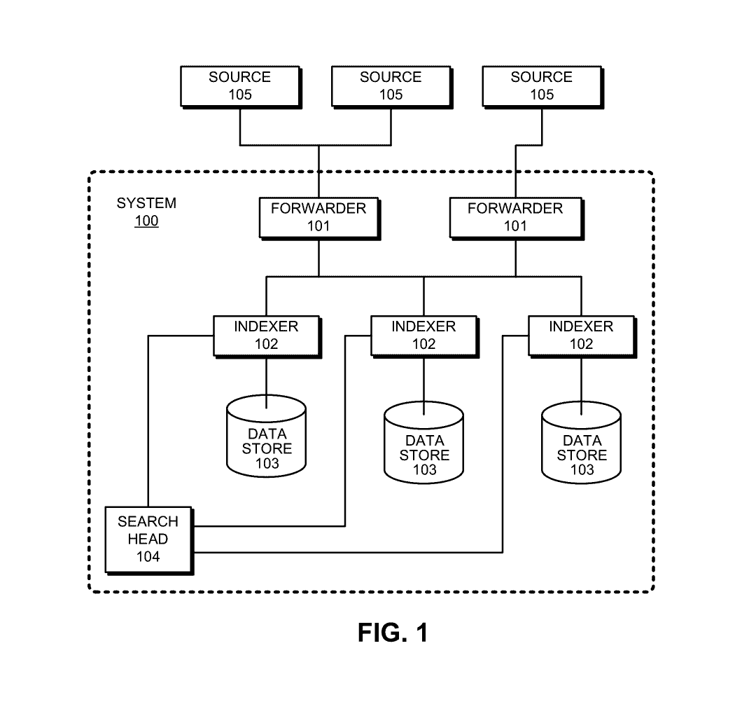

FIG. 1 presents a block diagram of an exemplary event-processing system 100, similar to the SPLUNK® ENTERPRISE system. System 100 includes one or more forwarders 101 that collect data obtained from a variety of different data sources 105, and one or more indexers 102 that store, process, and/or perform operations on this data, wherein each indexer operates on data contained in a specific data store 103. These forwarders and indexers can comprise separate computer systems in a data center, or may alternatively comprise separate processes executing on various computer systems in a data center.

During operation, the forwarders 101 identify which indexers 102 will receive the collected data and then forward the data to the identified indexers. Forwarders 101 can also perform operations to strip out extraneous data and detect timestamps in the data. The forwarders next determine which indexers 102 will receive each data item and then forward the data items to the determined indexers 102.

Note that distributing data across different indexers facilitates parallel processing. This parallel processing can take place at data ingestion time, because multiple indexers can process the incoming data in parallel. The parallel processing can also take place at search time, because multiple indexers can search through the data in parallel.

System 100 and the processes described below with respect to FIGS. 1-5 are further described in “Exploring Splunk Search Processing Language (SPL) Primer and Cookbook” by David Carasso, CITO Research, 2012, and in “Optimizing Data Analysis With a Semi-Structured Time Series Database” by Ledion Bitincka, Archana Ganapathi, Stephen Sorkin, and Steve Zhang, SLAML, 2010, each of which is hereby incorporated herein by reference in its entirety for all purposes.

### 1.3 Data Ingestion

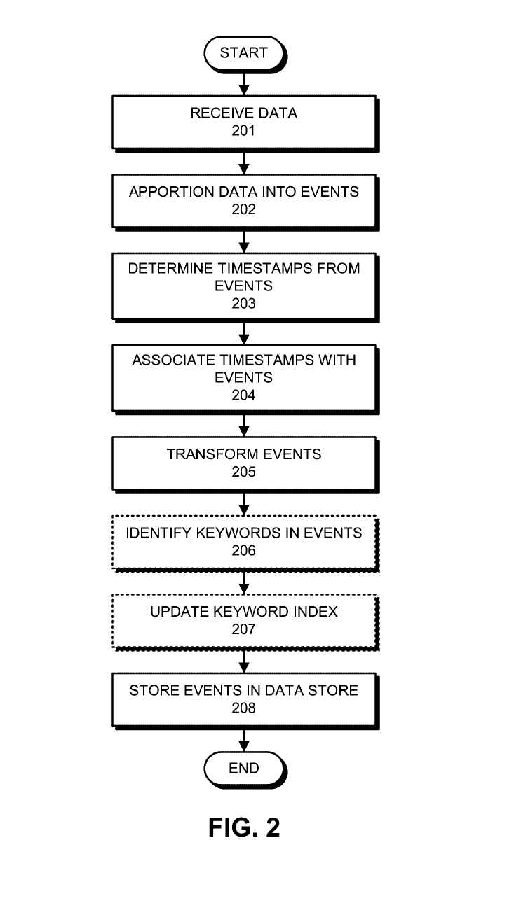

FIG. 2 presents a flow chart illustrating how an indexer processes, indexes, and stores data received from forwarders in accordance with the disclosed embodiments. At block 201, the indexer receives the data from the forwarder. Next, at block 202, the indexer apportions the data into events. Note that the data can include lines of text that are separated by carriage returns or line breaks and an event may include one or more of these lines. During the apportioning process, the indexer can use heuristic rules to automatically determine the boundaries of the events, which for example coincide with line boundaries. These heuristic rules may be determined based on the source of the data, wherein the indexer can be explicitly informed about the source of the data or can infer the source of the data by examining the data. These heuristic rules can include regular expression-based rules or delimiter-based rules for determining event boundaries, wherein the event boundaries may be indicated by predefined characters or character strings. These predefined characters may include punctuation marks or other special characters including, for example, carriage returns, tabs, spaces or line breaks. In some cases, a user can fine-tune or configure the rules that the indexers use to determine event boundaries in order to adapt the rules to the user's specific requirements.

Next, the indexer determines a timestamp for each event at block 203. As mentioned above, these timestamps can be determined by extracting the time directly from data in the event, or by interpolating the time based on timestamps from temporally proximate events. In some cases, a timestamp can be determined based on the time the data was received or generated. The indexer subsequently associates the determined timestamp with each event at block 204, for example by storing the timestamp as metadata for each event.

Then, the system can apply transformations to data to be included in events at block 205. For log data, such transformations can include removing a portion of an event (e.g., a portion used to define event boundaries, extraneous text, characters, etc.) or removing redundant portions of an event. Note that a user can specify portions to be removed using a regular expression or any other possible technique.

Next, a keyword index can optionally be generated to facilitate fast keyword searching for events. To build a keyword index, the indexer first identifies a set of keywords in block 206. Then, at block 207 the indexer includes the identified keywords in an index, which associates each stored keyword with references to events containing that keyword (or to locations within events where that keyword is located). When an indexer subsequently receives a keyword-based query, the indexer can access the keyword index to quickly identify events containing the keyword.

In some embodiments, the keyword index may include entries for name-value pairs found in events, wherein a name-value pair can include a pair of keywords connected by a symbol, such as an equals sign or colon. In this way, events containing these name-value pairs can be quickly located. In some embodiments, fields can automatically be generated for some or all of the name-value pairs at the time of indexing. For example, if the string “dest=10.0.1.2” is found in an event, a field named “dest” may be created for the event, and assigned a value of “10.0.1.2.”

Finally, the indexer stores the events in a data store at block 208, wherein a timestamp can be stored with each event to facilitate searching for events based on a time range. In some cases, the stored events are organized into a plurality of buckets, wherein each bucket stores events associated with a specific time range. This not only improves time-based searches, but it also allows events with recent timestamps that may have a higher likelihood of being accessed to be stored in faster memory to facilitate faster retrieval. For example, a bucket containing the most recent events can be stored as flash memory instead of on hard disk.

Each indexer 102 is responsible for storing and searching a subset of the events contained in a corresponding data store 103. By distributing events among the indexers and data stores, the indexers can analyze events for a query in parallel, for example using map-reduce techniques, wherein each indexer returns partial responses for a subset of events to a search head that combines the results to produce an answer for the query. By storing events in buckets for specific time ranges, an indexer may further optimize searching by looking only in buckets for time ranges that are relevant to a query.

Moreover, events and buckets can also be replicated across different indexers and data stores to facilitate high availability and disaster recovery as is described in U.S. patent application Ser. No. 14/266,812 filed on 30 Apr. 2014, and in U.S. patent application Ser. No. 14/266,817 also filed on 30 Apr. 2014.

### 1.4 Query Processing

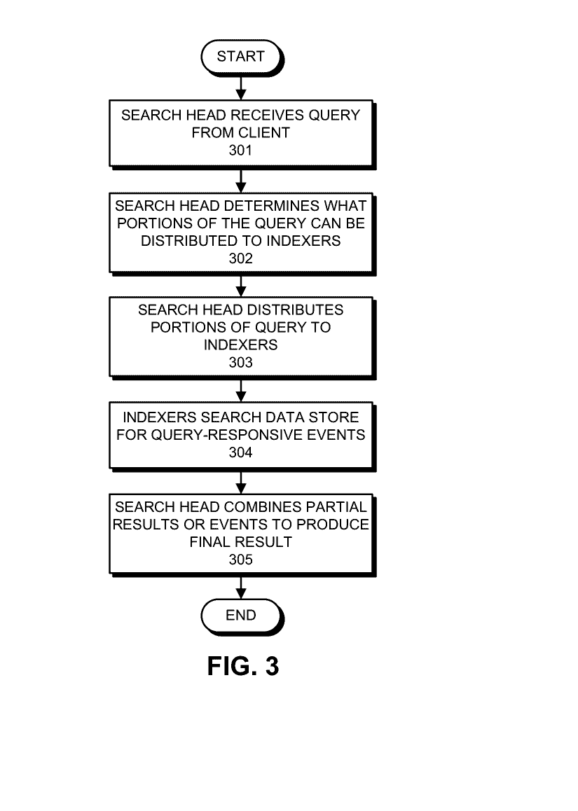

FIG. 3 presents a flow chart illustrating how a search head and indexers perform a search query in accordance with the disclosed embodiments. At the start of this process, a search head receives a search query from a client at block 301. Next, at block 302, the search head analyzes the search query to determine what portions can be delegated to indexers and what portions need to be executed locally by the search head. At block 303, the search head distributes the determined portions of the query to the indexers. Note that commands that operate on single events can be trivially delegated to the indexers, while commands that involve events from multiple indexers are harder to delegate.

Then, at block 304, the indexers to which the query was distributed search their data stores for events that are responsive to the query. To determine which events are responsive to the query, the indexer searches for events that match the criteria specified in the query. This criteria can include matching keywords or specific values for certain fields. In a query that uses a late-binding schema, the searching operations in block 304 may involve using the late-binding scheme to extract values for specified fields from events at the time the query is processed. Next, the indexers can either send the relevant events back to the search head, or use the events to calculate a partial result, and send the partial result back to the search head.

Finally, at block 305, the search head combines the partial results and/or events received from the indexers to produce a final result for the query. This final result can comprise different types of data depending upon what the query is asking for. For example, the final results can include a listing of matching events returned by the query, or some type of visualization of data from the returned events. In another example, the final result can include one or more calculated values derived from the matching events.

Moreover, the results generated by system 100 can be returned to a client using different techniques. For example, one technique streams results back to a client in real-time as they are identified. Another technique waits to report results to the client until a complete set of results is ready to return to the client. Yet another technique streams interim results back to the client in real-time until a complete set of results is ready, and then returns the complete set of results to the client. In another technique, certain results are stored as “search jobs,” and the client may subsequently retrieve the results by referencing the search jobs.

The search head can also perform various operations to make the search more efficient. For example, before the search head starts executing a query, the search head can determine a time range for the query and a set of common keywords that all matching events must include. Next, the search head can use these parameters to query the indexers to obtain a superset of the eventual results. Then, during a filtering stage, the search head can perform field-extraction operations on the superset to produce a reduced set of search results.

### 1.5 Field Extraction

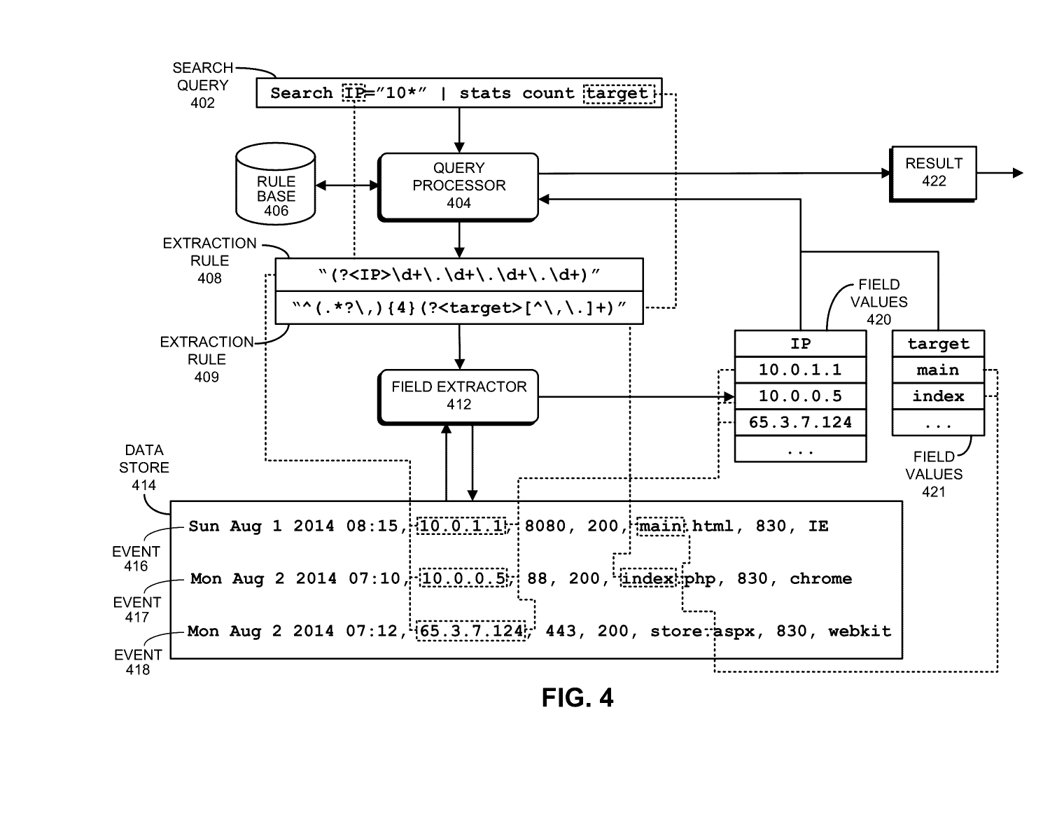

FIG. 4 presents a block diagram illustrating how fields can be extracted during query processing in accordance with the disclosed embodiments. At the start of this process, a search query 402 is received at a query processor 404. Query processor 404 includes various mechanisms for processing a query, wherein these mechanisms can reside in a search head 104 and/or an indexer 102. Note that the exemplary search query 402 illustrated in FIG. 4 is expressed in the Search Processing Language (SPL), which is used in conjunction with the SPLUNK® ENTERPRISE system. SPL is a pipelined search language in which a set of inputs is operated on by a first command in a command line, and then a subsequent command following the pipe symbol “I” operates on the results produced by the first command, and so on for additional commands. Search query 402 can also be expressed in other query languages, such as the Structured Query Language (“SQL”) or any suitable query language.

Upon receiving search query 402, query processor 404 sees that search query 402 includes two fields “IP” and “target.” Query processor 404 also determines that the values for the “IP” and “target” fields have not already been extracted from events in data store 414, and consequently determines that query processor 404 needs to use extraction rules to extract values for the fields. Hence, query processor 404 performs a lookup for the extraction rules in a rule base 406, wherein rule base 406 maps field names to corresponding extraction rules and obtains extraction rules 408-409, wherein extraction rule 408 specifies how to extract a value for the “IP” field from an event, and extraction rule 409 specifies how to extract a value for the “target” field from an event. As is illustrated in FIG. 4, extraction rules 408-409 can comprise regular expressions that specify how to extract values for the relevant fields. Such regular-expression-based extraction rules are also referred to as “regex rules.” In addition to specifying how to extract field values, the extraction rules may also include instructions for deriving a field value by performing a function on a character string or value retrieved by the extraction rule. For example, a transformation rule may truncate a character string, or convert the character string into a different data format. In some cases, the query itself can specify one or more extraction rules.

Next, query processor 404 sends extraction rules 408-409 to a field extractor 412, which applies extraction rules 408-409 to events 416-418 in a data store 414. Note that data store 414 can include one or more data stores, and extraction rules 408-409 can be applied to large numbers of events in data store 414, and are not meant to be limited to the three events 416-418 illustrated in FIG. 4. Moreover, the query processor 404 can instruct field extractor 412 to apply the extraction rules to all the events in a data store 414, or to a subset of the events that has been filtered based on some criteria.

Next, field extractor 412 applies extraction rule 408 for the first command Search IP=“10*” to events in data store 414 including events 416-418. Extraction rule 408 is used to extract values for the IP address field from events in data store 414 by looking for a pattern of one or more digits, followed by a period, followed again by one or more digits, followed by another period, followed again by one or more digits, followed by another period, and followed again by one or more digits. Next, field extractor 412 returns field values 420 to query processor 404, which uses the criterion IP=“10*” to look for IP addresses that start with “10”. Note that events 416 and 417 match this criterion, but event 418 does not, so the result set for the first command is events 416-417.

Query processor 404 then sends events 416-417 to the next command “stats count target.” To process this command, query processor 404 causes field extractor 412 to apply extraction rule 409 to events 416-417. Extraction rule 409 is used to extract values for the target field for events 416-417 by skipping the first four commas in events 416-417, and then extracting all of the following characters until a comma or period is reached. Next, field extractor 412 returns field values 421 to query processor 404, which executes the command “stats count target” to count the number of unique values contained in the target fields, which in this example produces the value “2” that is returned as a final result 422 for the query.

Note that query results can be returned to a client, a search head, or any other system component for further processing. In general, query results may include: a set of one or more events; a set of one or more values obtained from the events; a subset of the values; statistics calculated based on the values; a report containing the values; or a visualization, such as a graph or chart, generated from the values.

### 1.6 Exemplary Search Screen

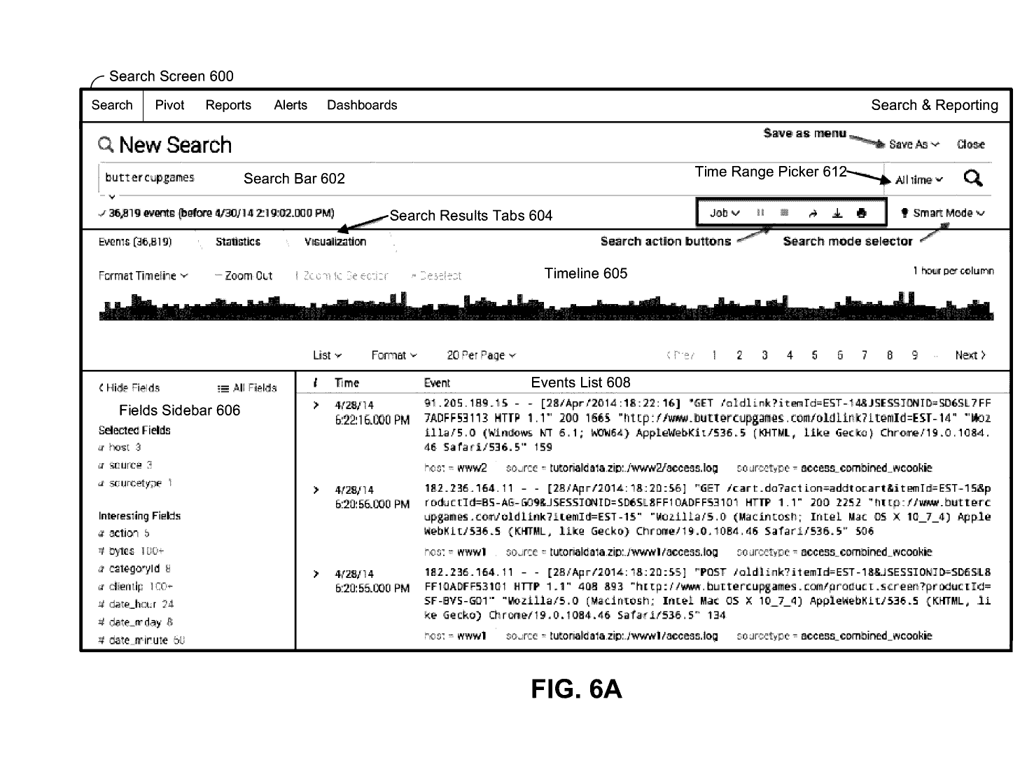

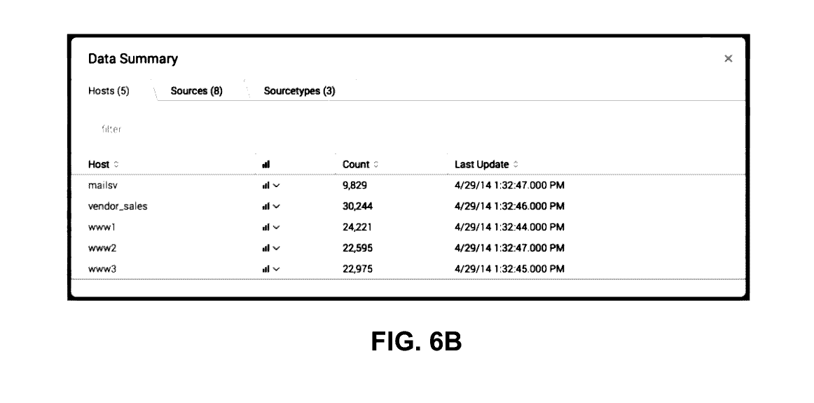

FIG. 6A illustrates an exemplary search screen 600 in accordance with the disclosed embodiments. Search screen 600 includes a search bar 602 that accepts user input in the form of a search string. It also includes a time range picker 612 that enables the user to specify a time range for the search. For “historical searches” the user can select a specific time range, or alternatively a relative time range, such as “today,” “yesterday” or “last week.” For “real-time searches,” the user can select the size of a preceding time window to search for real-time events. Search screen 600 also initially displays a “data summary” dialog as is illustrated in FIG. 6B that enables the user to select different sources for the event data, for example by selecting specific hosts and log files.

After the search is executed, the search screen 600 can display the results through search results tabs 604, wherein search results tabs 604 includes: an “events tab” that displays various information about events returned by the search; a “statistics tab” that displays statistics about the search results; and a “visualization tab” that displays various visualizations of the search results. The events tab illustrated in FIG. 6A displays a timeline graph 605 that graphically illustrates the number of events that occurred in one-hour intervals over the selected time range. It also displays an events list 608 that enables a user to view the raw data in each of the returned events. It additionally displays a fields sidebar 606 that includes statistics about occurrences of specific fields in the returned events, including “selected fields” that are pre-selected by the user, and “interesting fields” that are automatically selected by the system based on pre-specified criteria.

### 1.7 Acceleration Techniques

The above-described system provides significant flexibility by enabling a user to analyze massive quantities of minimally processed performance data “on the fly” at search time instead of storing pre-specified portions of the performance data in a database at ingestion time. This flexibility enables a user to see correlations in the performance data and perform subsequent queries to examine interesting aspects of the performance data that may not have been apparent at ingestion time.

However, performing extraction and analysis operations at search time can involve a large amount of data and require a large number of computational operations, which can cause considerable delays while processing the queries. Fortunately, a number of acceleration techniques have been developed to speed up analysis operations performed at search time. These techniques include: (1) performing search operations in parallel by formulating a search as a map-reduce computation; (2) using a keyword index; (3) using a high performance analytics store; and (4) accelerating the process of generating reports. These techniques are described in more detail below.

### 1.7.1 Map-Reduce Technique

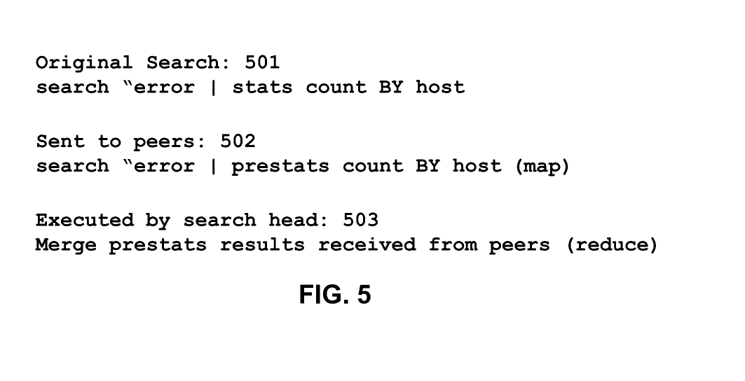

To facilitate faster query processing, a query can be structured as a map-reduce computation, wherein the “map” operations are delegated to the indexers, while the corresponding “reduce” operations are performed locally at the search head. For example, FIG. 5 illustrates how a search query 501 received from a client at search head 104 can split into two phases, including: (1) a “map phase” comprising subtasks 502 (e.g., data retrieval or simple filtering) that may be performed in parallel and are “mapped” to indexers 102 for execution, and (2) a “reduce phase” comprising a merging operation 503 to be executed by the search head when the results are ultimately collected from the indexers.

During operation, upon receiving search query 501, search head 104 modifies search query 501 by substituting “stats” with “prestats” to produce search query 502, and then distributes search query 502 to one or more distributed indexers, which are also referred to as “search peers.” Note that search queries may generally specify search criteria or operations to be performed on events that meet the search criteria. Search queries may also specify field names, as well as search criteria for the values in the fields or operations to be performed on the values in the fields. Moreover, the search head may distribute the full search query to the search peers as is illustrated in FIG. 3, or may alternatively distribute a modified version (e.g., a more restricted version) of the search query to the search peers. In this example, the indexers are responsible for producing the results and sending them to the search head. After the indexers return the results to the search head, the search head performs the merging operations 503 on the results. Note that by executing the computation in this way, the system effectively distributes the computational operations while minimizing data transfers.

### 1.7.2 Keyword Index

As described above with reference to the flow charts in FIGS. 2 and 3, event-processing system 100 can construct and maintain one or more keyword indexes to facilitate rapidly identifying events containing specific keywords. This can greatly speed up the processing of queries involving specific keywords. As mentioned above, to build a keyword index, an indexer first identifies a set of keywords. Then, the indexer includes the identified keywords in an index, which associates each stored keyword with references to events containing that keyword, or to locations within events where that keyword is located. When an indexer subsequently receives a keyword-based query, the indexer can access the keyword index to quickly identify events containing the keyword.

### 1.7.3 High Performance Analytics Store

To speed up certain types of queries, some embodiments of system 100 make use of a high performance analytics store, which is referred to as a “summarization table,” that contains entries for specific field-value pairs. Each of these entries keeps track of instances of a specific value in a specific field in the event data and includes references to events containing the specific value in the specific field. For example, an exemplary entry in a summarization table can keep track of occurrences of the value “94107” in a “ZIP code” field of a set of events, wherein the entry includes references to all of the events that contain the value “94107” in the ZIP code field. This enables the system to quickly process queries that seek to determine how many events have a particular value for a particular field, because the system can examine the entry in the summarization table to count instances of the specific value in the field without having to go through the individual events or do extractions at search time. Also, if the system needs to process all events that have a specific field-value combination, the system can use the references in the summarization table entry to directly access the events to extract further information without having to search all of the events to find the specific field-value combination at search time.

In some embodiments, the system maintains a separate summarization table for each of the above-described time-specific buckets that stores events for a specific time range, wherein a bucket-specific summarization table includes entries for specific field-value combinations that occur in events in the specific bucket. Alternatively, the system can maintain a separate summarization table for each indexer, wherein the indexer-specific summarization table only includes entries for the events in a data store that is managed by the specific indexer.

The summarization table can be populated by running a “collection query” that scans a set of events to find instances of a specific field-value combination, or alternatively instances of all field-value combinations for a specific field. A collection query can be initiated by a user, or can be scheduled to occur automatically at specific time intervals. A collection query can also be automatically launched in response to a query that asks for a specific field-value combination.

In some cases, the summarization tables may not cover all of the events that are relevant to a query. In this case, the system can use the summarization tables to obtain partial results for the events that are covered by summarization tables, but may also have to search through other events that are not covered by the summarization tables to produce additional results. These additional results can then be combined with the partial results to produce a final set of results for the query. This summarization table and associated techniques are described in more detail in U.S. Pat. No. 8,682,925, issued on Mar. 25, 2014.

### 1.7.4 Accelerating Report Generation

In some embodiments, a data server system such as the SPLUNK® ENTERPRISE system can accelerate the process of periodically generating updated reports based on query results. To accelerate this process, a summarization engine automatically examines the query to determine whether generation of updated reports can be accelerated by creating intermediate summaries. (This is possible if results from preceding time periods can be computed separately and combined to generate an updated report. In some cases, it is not possible to combine such incremental results, for example where a value in the report depends on relationships between events from different time periods.) If reports can be accelerated, the summarization engine periodically generates a summary covering data obtained during a latest non-overlapping time period. For example, where the query seeks events meeting a specified criteria, a summary for the time period includes only events within the time period that meet the specified criteria. Similarly, if the query seeks statistics calculated from the events, such as the number of events that match the specified criteria, then the summary for the time period includes the number of events in the period that match the specified criteria.

In parallel with the creation of the summaries, the summarization engine schedules the periodic updating of the report associated with the query. During each scheduled report update, the query engine determines whether intermediate summaries have been generated covering portions of the time period covered by the report update. If so, then the report is generated based on the information contained in the summaries. Also, if additional event data has been received and has not yet been summarized, and is required to generate the complete report, the query can be run on this additional event data. Then, the results returned by this query on the additional event data, along with the partial results obtained from the intermediate summaries, can be combined to generate the updated report. This process is repeated each time the report is updated. Alternatively, if the system stores events in buckets covering specific time ranges, then the summaries can be generated on a bucket-by-bucket basis. Note that producing intermediate summaries can save the work involved in re-running the query for previous time periods, so only the newer event data needs to be processed while generating an updated report. These report acceleration techniques are described in more detail in U.S. Pat. No. 8,589,403, issued on Nov. 19, 2013, and U.S. Pat. No. 8,412,696, issued on Apr. 2, 2011.

### Facilitating Execution of External Commands During Query Processing

The disclosed embodiments provide a technique for executing custom search commands during query processing. If a user wants to perform a specific transformation on events, and this transformation is not provided for in the existing search language, the system allows the user to define a custom search command to perform the transformation.

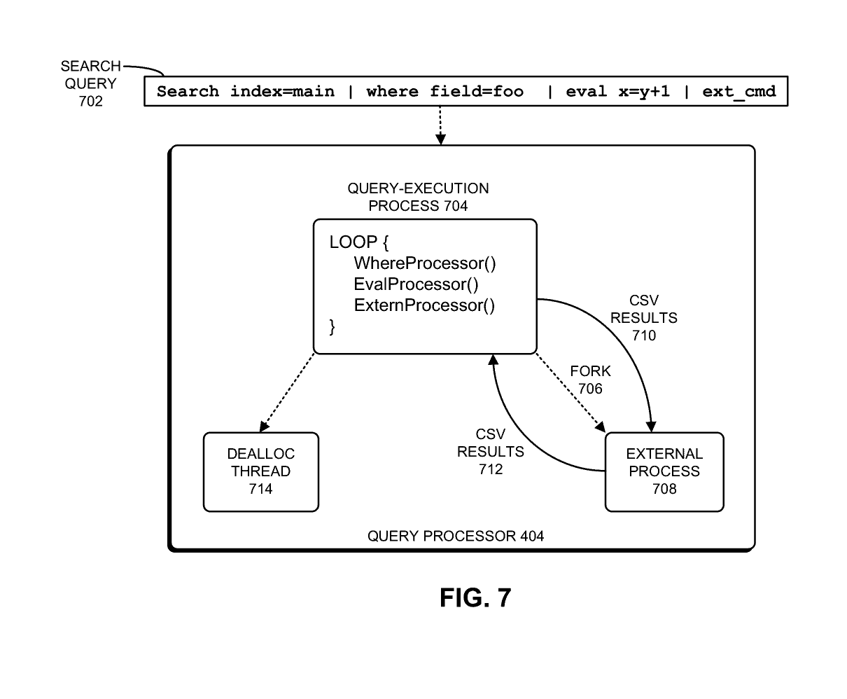

In some embodiments, this technique provides a mechanism that triggers a script to execute code for the custom search command. For example, in one embodiment, a custom search command can be defined in a configuration file “commands.conf,” which includes a stanza for each custom search command, wherein the stanza specifies the name of the custom search command, as well as a path to the corresponding script. The script can be referenced by a user-defined command name and can be incorporated into a normal execution pipeline as is illustrated in search query 702 in FIG. 7. Note that this custom search command looks like a normal search command. We can stream events to it though stdin, we get results from it through stdout, and the results percolate through the rest of the search pipeline.

This system allows external search commands to be written in different programming languages. This is advantageous because it is often easier to write commands in a higher-level language, such as Python, instead of a lower-level language, such as C++. Hence, in some embodiments, to facilitate programming in different languages, the system provides software development kits (SDKs) for different programming languages, such as a Java SDK, a Python SDK and a C# SDK.

As illustrated in FIG. 7, during operation of the system, a query processor 404 (also illustrated in FIG. 4) operates on a search query 702. Search query 702 starts with a generating search “index=main” that generates events. Search query 702 also includes a number of search operators, including “where field=foo,” “eval x=y+1” and “ext_cmd,” which are linked by pipe symbols “I”. Note that the “where” search operator and the “eval” search operator are defined in the search language, whereas the “ext_cmd” search operator is an external custom search command that is not defined in the standard search language.

Query processor 404 includes a query-execution process 704 that performs the search. While performing the search, the system separates the individual search operators “where,” “eval” and “ext_cmd” that are delimited by the pipe symbols. The system then instantiates processors for these search operators, including “WhereProcessor( )” “EvalProcessor” and “ExternProcessor( )” and places these processors in a loop so they can execute on all of the events as they pass through the pipeline.

Note that the processor for the external search command, ExternProcessor( ) implements the same interface as any of the other processors. It interfaces with a process_arguments( )method, and an execute( )method, wherein the execute( )method is defined within ExternProcessor ( ).

Also, note that the process_arguments( )method is called only once at the beginning of the search to initialize ExternProcessor( ) In contrast, the execute( )method gets called repeatedly for each chunk of events.

When the system initially calls process_arguments( ) the process_arguments( )method parses all of the supplied arguments, and also performs a fork operation 706 to create an external process 708, which can, for example, run under Python. The system also wires stdin and stdout to this external process 708. Next, whenever execute( ) is subsequently called to execute on a chunk of events, a set of CSV results 710 (containing events) gets sent on stdin to external process 708, and in response a corresponding set of CSV results 712 is returned on stdout. Finally, after the search is complete, the system calls a “destructor” to terminate all of the processes. At this point, the system terminates external process 708.

Note that external process 708 is only started once, at the beginning of the search, and is not terminated throughout the search to process chunks of event data, and is finally terminated at the end of the search process. This eliminates the overhead involved in repeatedly starting and terminating external process 708 for each chunk containing events. In some cases, starting the process involves a time-consuming operation to import a library, so reducing the number of times the process is started would also reduce the number of time-consuming operations to import the library.

Also note that external process 708 can possibly execute on a different processor core than query-execution process 704. This means external process 708 can execute in parallel with query-execution process 704, which can improve system performance. Note that if the system is executing multiple external search commands, the multiple commands can all be executed in parallel.

In some embodiments, query-execution process 704 also starts a separate deallocation thread 714, which is responsible for deallocating memory objects (e.g., deleting events). This can improve performance because instead of having to wait for events to be deleted, the system can place events to delete into a to-be-deleted queue, and can continue executing while deallocation thread 714 deallocates these events in the background.

### Transport Protocol

In general, any type of transport protocol can be used to send events or parts of events between query-execution process 704 and external process 708. In some embodiments, the basic flow-control contract for the transport protocol is “chunk-for-chunk.” More specifically, query-execution process 704 sends a chunk (CSV in) containing events to external process 708 and receives a corresponding processed chunk (CSV out) in return, wherein the returned chunk serves as an acknowledgment.

Some embodiments also support sending a single chunk to external process 708 and in return receiving multiple “partial chunks.” This can be accomplished by including a flag in the returned chunk that indicates whether the protocol is “finished,” which means that the returned chunk is the final chunk, or whether the protocol is “not finished” and additional partial chunks will be returned. Note that if the external process enriches the events, the events can possibly grow in size, which may make it desirable to return multiple partial chunks instead of one very large chunk.

### Process of Executing a Query

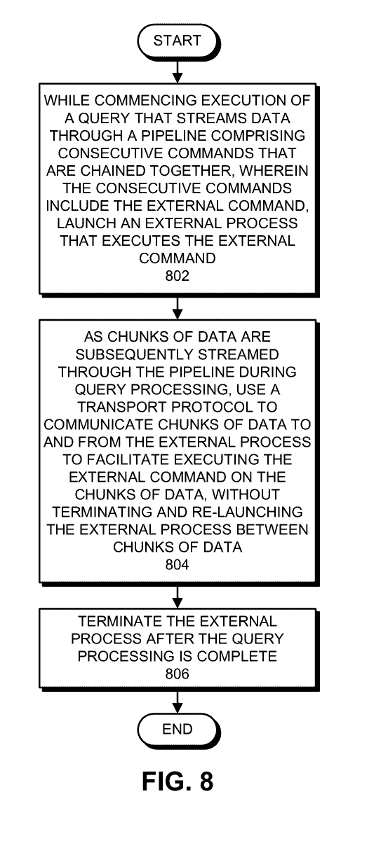

FIG. 8 presents a flow chart illustrating the process of executing a query that includes an external search command in accordance with the disclosed embodiments. While commencing execution of a query that streams data through a pipeline comprising consecutive commands that are chained together (including the external command), the system launches an external process that executes the external command (step 802). Next, as chunks of data are subsequently streamed through the pipeline during query processing, the system uses a transport protocol to communicate chunks of data to and from the external process to facilitate executing the external command on the chunks of data, without terminating and re-launching the external process between chunks of data (step 804). Finally, the system terminates the external process after the query processing is complete (step 806).

### Selected-Fields Mode

In many cases, an external process will only require access to a small subset of fields in the events, so sending all of the data in each event to and from the external process is not necessary. This can be accomplished by maintaining a “selected-fields list” for the external process, and then only sending the selected fields from each event to the external process. This enables the external process to edit the fields, add new fields, or remove events entirely. Note that this optimization allows the system to serialize far less data for exchange with the external process, while still maintaining a much larger result set. Moreover, this optimization is ideal for commands that filter out records based on the value of a single field, or want to enrich records based on the value of a few fields. While implementing this selected-fields mode, the system maintains a correspondence between input events and output events, so that the output of the external command can be merged with the full result set. This can be accomplished by adding an index field to the records containing the selected fields, wherein the index fields are populated with ascending numbers starting from zero. Note that the external command must not change the value of this index field.

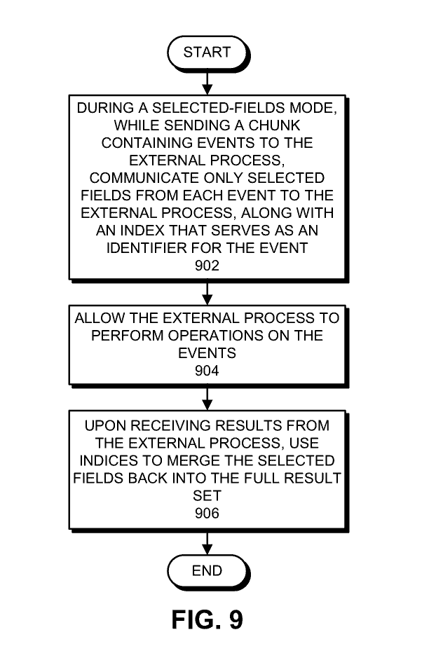

The selected-fields mode generally operates as is illustrated in the flow chart that appears in FIG. 9. When the system is sending a chunk containing events to the external process during a selected-fields mode, the system communicates only selected fields from each event to the external process, along with an index that serves as an identifier for the event (step 902). Next, the system allows the external process to perform operations on events in the chunk of data, such as editing fields, adding new fields and removing events (step 904). Finally, upon receiving results from the external process, the system uses the indices for the events to merge the selected fields back into the full result set, which involves possibly deleting events (step 906). (Note that the system does not incorporate the indices into the full result set.)

Note that all of the above-described techniques can be applied in a distributed cloud-based computer system, in which different processes can be executed on geographically distributed processors, as well as a conventional “on-premises” computer system, wherein all of the processes execute on processors that reside locally. Moreover, note that all of the above-described techniques and associated structures can be applied to both cloud-based computer systems and on-premises computer systems.

The preceding description was presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein. Accordingly, many modifications and variations will be apparent to practitioners skilled in the art. Additionally, the above disclosure is not intended to limit the present description. The scope of the present description is defined by the appended claims.

The data structures and code described in this detailed description are typically stored on a computer-readable storage medium, which may be any device or medium that can store code and/or data for use by a system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored on a non-transitory computer-readable storage medium as described above. When a system reads and executes the code and/or data stored on the non-transitory computer-readable storage medium, the system performs the methods and processes embodied as data structures and code and stored within the non-transitory computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

What is claimed is:

1. A computer-implemented method for executing an external command during query processing, comprising:
while commencing execution of a query that executes one or more commands including the external command, launching an external process that executes the external command; and
as chunks of data are subsequently processed using the one or more commands during query processing, using a transport protocol to communicate the chunks of data to and from the external process to facilitate executing the external command on the chunks of data, without terminating and re-launching the external process between the chunks of data.

2. The computer-implemented method of claim 1, wherein executing the one or more commands includes streaming the chunks of data through a pipeline comprising the one or more commands, which are consecutively chained together in the pipeline.

3. The computer-implemented method of claim 1, wherein the method further comprises terminating the external process after the query processing is complete.

4. The computer-implemented method of claim 1, wherein the transport protocol supports a partial-chunk mode, during which a single chunk is sent to the external process, and in response, multiple partial chunks are received from the external process.

5. The computer-implemented method of claim 1, wherein the data comprises events containing previously gathered data.

6. The computer-implemented method of claim 1,
wherein the data comprises events containing previously gathered data; and
wherein during a selected-fields mode, communicating the chunks of data to and from the external process includes communicating only selected fields from each of the events in the chunks of data to the external process.

7. The computer-implemented method of claim 1,
wherein the data comprises events containing previously gathered data; and
wherein the external process does at least one of the following:
edits one or more fields in the events;
adds one or more fields to the events;
adds one or more new events; and
removes one or more events entirely.

8. The computer-implemented method of claim 1,
wherein the data comprises events containing previously gathered data; and
wherein the method further comprises spawning a separate thread to deallocate events that have been deleted.

9. The computer-implemented method of claim 1, wherein the external process executes an externally defined script.

10. The computer-implemented method of claim 1, wherein the external process is configured to execute code specified in multiple programming languages.

11. The computer-implemented method of claim 1, wherein the chunks of data comprise events containing raw data associated with a time stamp.

12. The computer-implemented method of claim 1,
wherein the chunks of data comprise time-stamped events containing raw data associated with a time stamp; and
wherein processing the chunks of data using the one or more commands includes using one or more extraction rules generated from the query to obtain data to be processed from the events.

13. The computer-implemented method of claim 1, wherein using the transport protocol to communicate the chunks of data to and from the external process includes:
sending a chunk of data to the external process; and
in return, receiving a processed chunk of data, wherein the processed chunk of data indicates that the external process is ready to receive another chunk of data.

14. The computer-implemented method of claim 1, wherein the method facilitates executing a query using external commands as well as internal commands defined in a query language, without incurring the overhead involved in terminating and re-launching the external process between chunks of data.

15. The computer-implemented method of claim 1, wherein the external process is configured to execute code specified in the Python programming language.

16. A non-transitory computer-readable storage medium storing instructions that when executed by a computer cause the computer to perform a method for executing an external command during query processing, the storage medium including:
launching instructions for launching an external process that executes the external command, wherein the launching instructions are executed while commencing execution of a query that executes one or more commands including the external command; and
communication instructions that implement a transport protocol to communicate chunks of data to and from the external process to facilitate executing the external command on the chunks of data, without terminating and re-launching the external process between the chunks of data, wherein the communication instructions execute while the chunks of data are subsequently processed using the one or more commands during query processing.

17. The non-transitory computer-readable storage medium of claim 16, wherein executing the one or more commands includes streaming the chunks of data through a pipeline comprising the one or more commands, which are consecutively chained together in the pipeline.

18. The non-transitory computer-readable storage medium of claim 16, wherein the storage medium further includes instructions for terminating the external process after the query processing is complete.

19. The non-transitory computer-readable storage medium of claim 16, wherein the transport protocol supports a partial-chunk mode, during which a single chunk is sent to the external process, and in response, multiple partial chunks are received from the external process.

20. The non-transitory computer-readable storage medium of claim 16,
wherein the data comprises events containing previously gathered data; and
wherein during a selected-fields mode, communicating the chunks of data to and from the external process includes communicating only selected fields from each of the events in the chunks of data to the external process.

21. The non-transitory computer-readable storage medium of claim 16,
wherein the data comprises events containing previously gathered data; and
wherein the external process does at least one of the following:
edits one or more fields in the events;
adds one or more fields to the events;
adds one or more new events; and
removes one or more events entirely.

22. The non-transitory computer-readable storage medium of claim 16, wherein the chunks of data comprise events containing raw data associated with a time stamp.

23. The non-transitory computer-readable storage medium of claim 16, wherein the chunks of data comprise events containing raw data associated with a time stamp; and
wherein processing the chunks of data using the one or more commands includes using one or more extraction rules generated from the query to obtain data to be processed from the events.

24. A system that facilitates executing an external command during query processing, comprising:
at least one processor and at least one associated memory; and
a query-processing mechanism that executes on the at least one processor, wherein during operation, the query processing mechanism:
launches an external process that executes the external command while commencing execution of a query that executes one or more commands including the external command; and
as chunks of data are subsequently processed using the one or more commands during query processing, uses a transport protocol to communicate the chunks of data to and from the external process to facilitate executing the external command on the chunks of data, without terminating and re-launching the external process between the chunks of data.

25. The system of claim 24, wherein executing the one or more commands includes streaming the chunks of data through a pipeline comprising the one or more commands, which are consecutively chained together in the pipeline.

26. The system of claim 24, wherein the query-processing mechanism also terminates the external process after the query processing is complete.

27. The system of claim 24, wherein the transport protocol supports a partial-chunk mode, during which a single chunk is sent to the external process, and in response, multiple partial chunks are received from the external process.

28. The system of claim 24,
wherein the data comprises events containing previously gathered data; and
wherein during a selected-fields mode, communicating the chunks of data to and from the external process includes communicating only selected fields from each of the events in the chunks of data to the external process.

29. The system of claim 24, wherein the chunks of data comprise events containing raw data associated with a time stamp.

30. The system of claim 24,
wherein the chunks of data comprise events containing raw data associated with a time stamp; and
wherein processing the chunks of data using the one or more commands includes using one or more extraction rules generated from the query to obtain data to be processed from the events.
